(19) United States
(12) Patent Application Publication
(10) Pub. No.: US 2008/0310751 A1
(43) Pub. Date: Dec. 18, 2008

(54) Method And Apparatus For Providing A Variable Blur

(76) Inventors: Barinder Singh Rai, Surrey (CA); Jiliang Song, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/763,972

(22) Filed: Jun. 15, 2007

(51) Int. Cl. G06K 9/40

(52) U.S. Cl. 382/264

(57) ABSTRACT

A de-noising circuit for filtering image data is provided. The denoising circuit includes a buffer for storing a portion of the image data and detail detection circuitry configured to determine a filter coefficient to be applied to a reference pixel value within the portion of the image data. A blur filter configured to average values within the portion of the image data is included. The blur filter repeats the reference pixel value as specified by the filter coefficient to generate blurred image data. Selection circuitry configured to select between the blurred image data and the unfiltered image data based on a selection signal from the detail detection circuitry is included. A method for filtering image data and a device are also included.

### CROSS REFERENCE TO RELATED APPLICATIONS

This application is related to U.S. patent application Ser. No. ______, filed on ______, ______, and entitled “Method and Apparatus for Providing a Variable Filter Size,” the disclosure of this application is incorporated herein by reference in their entirety for all purposes.

### BACKGROUND

Many digital cameras, especially the lower quality digital cameras associated with cell phones or other portable electronic devices, do not produce very clear images of the pictures they capture. One of the reasons digital images are often of a low quality is because they use very small lenses due to physical space constraints on the portable devices. Smaller lenses inherently allow less light into the lens than larger ones. Less light results in a larger noise to signal ratio which produces a low quality image. The lack of a flash for the camera also introduces noise into the image data. Other factors for poor image quality include the digital sampling rate of the camera, the use of inexpensive lenses to keep the cost of the device low, and the limited computing resources of the portable device.

What is needed is a method and system that improves the quality of digital images captured through portable devices having limited computing resources.

### SUMMARY

Broadly speaking, the present invention fills these needs by providing a denoising circuit and method to enhance the quality of a digital image. It should be appreciated that the present invention can be implemented in numerous ways, including as a process, an apparatus, a system, a device, or a method. Several inventive embodiments of the present invention are described below.

In one embodiment, a method for providing a variable blur to improve picture quality is included. The method initiates with receiving captured image data. The method includes comparing a value representing a center pixel of a pixel matrix to each pixel value within the pixel matrix and summing differences between the center pixel value and each pixel value. The method includes selecting a blur level to filter the center pixel of the pixel matrix based on the summed differences.

In another embodiment, a de-noising circuit for filtering image data is provided. The de-noising circuit includes a buffer for storing a portion of the image data and detail detection circuitry configured to determine a filter coefficient to be applied to a reference pixel value within the portion of the image data. A blur filter configured to average values within the portion of the image data is included. The blur filter repeats the reference pixel value for the averaging as specified by the filter coefficient to generate blurred image data. Selection circuitry configured to select between the blurred image data and the unfiltered image data based on a selection signal from the detail detection circuitry is included.

In yet another embodiment, a portable device having image capture circuitry is provided. The portable device includes a graphics processor and de-noising circuitry. The de-noising circuitry is in communication with the image capture circuitry and the graphics processor. The de-noising circuitry includes a line buffer configured to receive a portion of captured image data from the image capture circuitry. The de-noising circuitry includes detail detection circuitry configured to calculate a difference between a center pixel value of the portion of captured image data and a remainder of pixel values within the portion of captured image data. The de-noising circuitry includes a blur filter configured to apply a blur level to the center pixel value.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a block diagram of a system for providing a variable blur, in accordance with one embodiment of the invention.

FIG. 2 is a block diagram illustrating components of the de-noise unit, in accordance with one embodiment of the present invention.

FIG. 3 is a simplified schematic diagram illustrating a view of a captured image with a corresponding pixel matrix, in accordance with one embodiment of the invention.

FIG. 4A is a simplified schematic diagram illustrating a view of a pixel matrix which has not yet entered an image area containing any detail, in accordance with one embodiment of the present invention.

FIG. 4B is a simplified schematic diagram illustrating a view of a pixel matrix which has entered an image area containing some detail, in accordance with one embodiment of the present invention.

FIG. 5 shows a representation of the detail detector and exemplary values stored in a register array, in accordance with one embodiment of the present invention.

FIG. 6 is a flow chart showing a method for providing a variable blur, in accordance with one embodiment of the present invention.

### DETAILED DESCRIPTION

An invention is described for methods, apparatuses, and systems for improving image data captured through a computing device having limited resources. It will be obvious, however, to one skilled in the art, that the present invention may be practiced without some or all of these specific details. In other instances, well known process operations have not been described in detail in order not to unnecessarily obscure the present invention.

The embodiments described herein provide methods, apparatuses, and systems for improving the quality of a displayed captured image. In one embodiment, a captured image is analyzed to determine which regions of the image are detail or transition portions, e.g., and edge. Once analyzed, the image quality can be improved by applying blurring techniques to specific regions. The blurring techniques described herein reduce the noise associated with the image data. The reduction of noise in the image is performed in a manner that prevents unnecessary distorting of the image, which may result in a loss of detail. The embodiments described herein may be integrated in a portable device having a camera. The device includes de-noising circuitry that buffers a portion of the captured image data and filters the portion of the data based on the differences in pixel value between a reference pixel and the remaining pixels in the portion of the data. That is, a blur level is selectively applied to the reference pixel based on the differences calculated above.

In one implementation, a 9×9 pixel matrix is initially analyzed to determine if a reference pixel of the pixel matrix should be filtered, i.e. blurred. It should be appreciated that the matrix sizes provided herein are exemplary, and that alternative matrix sizes larger or smaller may be chosen. In addition, it is not necessary that the matrix be square, as different numbers of rows and columns may be used. In another embodiment, the blur can be adaptively applied. That is, some regions may be blurred at one level, other regions may be blurred at a different level, and/or some regions may not be blurred at all. As will be explained in more detail below, a comparison is made between a center pixel value of a matrix and the remaining pixel values in the matrix by calculating the sum of the differences between the center pixel value and the remaining pixel values in the matrix. Then, the sum of the differences is compared to a threshold value and based on this comparison a blur level is chosen for the center pixel.

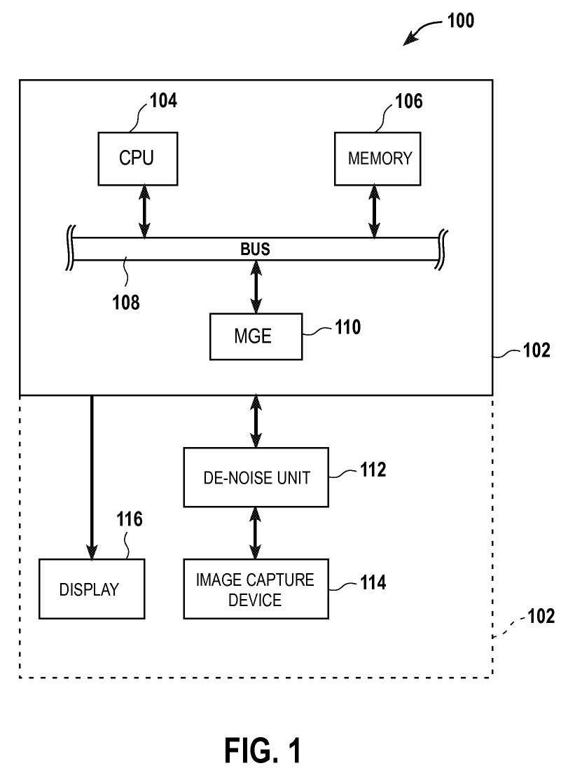

FIG. 1 is a block diagram that illustrates a system 100 for providing a variable blur that may be used to implement the invention. As shown in FIG. 1, a computing unit 102 includes a Central Processing Unit (CPU) 104, a memory 106, a bus 108, and a Mobile Graphics Engine (MGE) 110. Bus 108 provides a communication route through which data can travel between CPU 104, Memory 106, and MGE 10. Bus 108 may be implemented by any means that allow the functional units of computing unit 102 to communicate with each other. Computing unit 102 may be implemented on a Personal Computer (PC), a cell phone, a web tablet, a personal PC, a Personal Digital Assistant (PDA), a laptop, etc., each of which includes image capture capability. Although the foregoing are examples, it should be appreciated that any computing device, either portable or non-portable, may be used to implement the invention, even though the embodiments described herein are described with reference to a limited computing resource and battery powered device.

Computing unit 102 is in communication with image capture device 114 through a de-noise unit 112. It should be noted that image capture device 114 may be incorporated into a charged coupled device (CCD) or complementary metal oxide semiconductor (CMOS) chip. Computing unit 102 receives image data from the image capture device 114 via the de-noise unit 112 after a determination by de-noise unit 112 whether or not the image should be filtered. The image capture device 114 may be a stand-alone unit, or may be integrated into the computing unit 102. De-noise unit 112 may be constructed of discrete circuitry, logic gates, etc., and may be integrated onto computing device 102 or image capture device 104. Display 116 may be a computer monitor, a Liquid Crystal Display (LCD), or a Thin Film Transistor display of computing device 102.

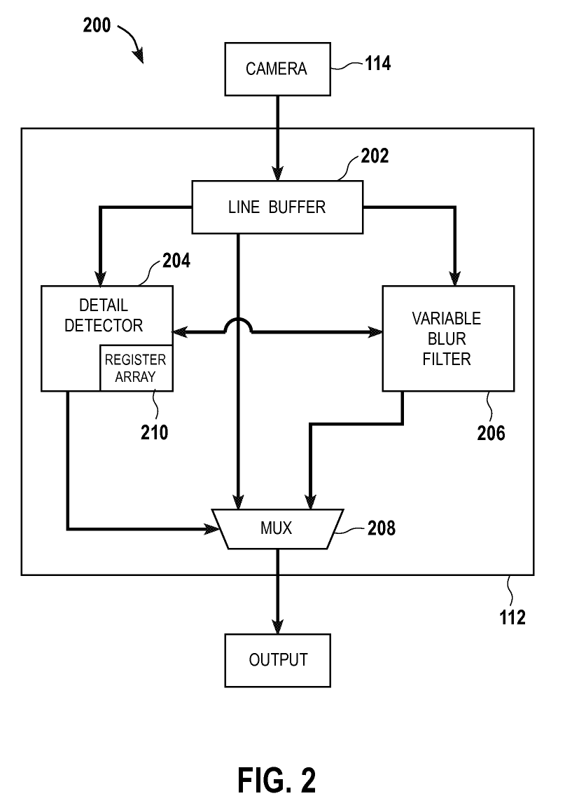

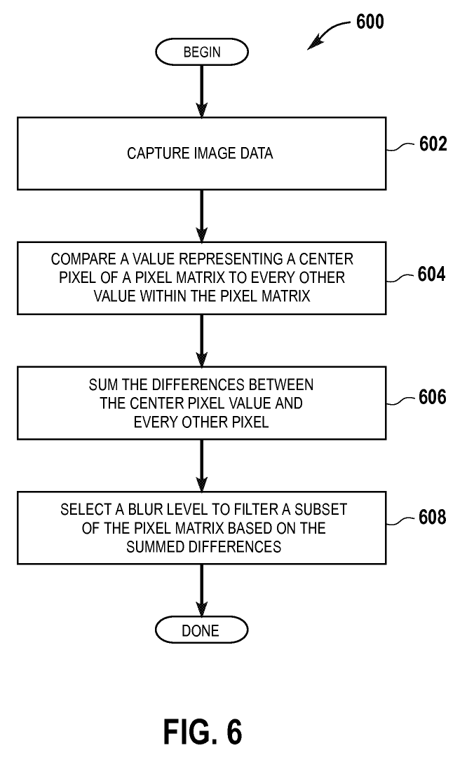

FIG. 2 is a block diagram 200 of the de-noise unit 112, in accordance with one embodiment of the present invention. De-noise unit 112 contains circuitry that analyzes the image data from image capture device 114, determines if portions of a captured image should be filtered to improve the quality of the image, and then passes on either filtered or unfiltered image data to computing unit 102 which will control the display of the image data. A line buffer 202 is configured to receive a portion of the captured image data from the image capture device 114. Line buffer 202 is a memory region used to hold a specific amount of image data, which may be a portion of the entire frame of image data to be displayed, in one embodiment. In one exemplary embodiment, line buffer 202 is 9 rows deep to accommodate data from a 9 row×9 column (9×9) pixel matrix. Of course, this is only one example of a matrix size and is not meant to be limiting, as any suitable matrix size may be used. Line buffer 202 provides data to the detail detector 204, variable blur filter 206, and also to multiplexer 208. Detail detector 204 contains circuitry configured to calculate a difference between a center pixel value of a portion of captured image data and a remainder of pixel values within the portion of captured image data. Detail detector 204 includes a register array 210. Register array 210 stores a plurality of threshold range values corresponding to respective coefficients. FIG. 6 further describes the relationship between threshold ranges and respective coefficients in more detail.

Detail detector 204 is in communication with variable blur filter 206 and multiplexer 208. Detail detector 204 includes circuitry configured to determine whether or not the image data from line buffer 202 is presented as filtered or unfiltered data. In this embodiment, this determination is made by comparing the sum of the differences calculated within a chosen matrix to a corresponding threshold value stored in register array 210. If the comparison of the sum of the differences and the threshold value indicates that the portion of the image data represented by the pixel matrix does not need to be filtered, then detail detector 204 instructs the multiplexer 208 via a control signal to output non-filtered image data. If detail detector 204 determines that the image data needs to be filtered, then detail detector 204 outputs a control signal selecting image data having a variable blur applied thereto. The detail detector 204 also instructs variable blur filter 206 on which coefficient stored in register array 210 to select to be applied to the image data from detail detector 206. As mentioned above, in one embodiment the sum of the differences (x) between a center pixel value and the remaining values in a chosen pixel matrix is calculated in detail detector 204. The sum is then compared to a threshold value stored in register array 210 in order to select a coefficient. In one embodiment, ranges may be chosen as illustrated in Table 1.

TABLE 1

| Exemplary | |
|---|---|
| Threshold Ranges | Coefficients |
| x < 100 | 1 |
| 100 ≦ x < 200 | 2 |
| 200 ≦ x < 300 | 3 |
| 300 ≦ x ≦ 500 | 4 |
| x > 500 | No Blur |

The threshold ranges correspond to an amount of detail, e.g., whether a selected region of the pixel matrix has detail or transition regions, such as edges. Where the sum of differences is <100, the region is classified as not having a transition or edge, therefore, a low blurring coefficient would be selected which results in a relatively large amount of blurring applied to the blurring area, i.e., the center or the reference pixel. In one embodiment, the blurring coefficient represents how many times to use the center value when calculating the average. That is, where the coefficient s one, the center value is used once to calculate the average, where the coefficient is two, the center value would be used twice, and so on. A threshold range of greater than 500 represents an area of great detail, i.e., an area where sharp transitions take place or an edge region is present in the pixel matrix area. Therefore, in order to preserve as much of the detail as possible, no blurring is applied to that region, i.e., no averaging takes place and the original center or reference pixel values are used when displaying the image. It should be appreciated by those of ordinary skill in the art that the threshold ranges and blurring coefficients given in Table 1 are only one possible embodiment, and many other values are possible. Thus, the exemplary ranges in Table 1 are not meant to be limiting. Furthermore, the data from Table 1 is provided to variable blur filter 206 from detail detector 204.

Variable blur filter 206 is in communication with multiplexer 208. If the detail detector 204 indicated that the center or reference pixel should be filtered, then detail detector 206 instructs the multiplexer 208 via the control signal to output the filtered data that the multiplexer 208 received from variable blur filter 206. Of course, the filtered data is obtained by averaging the pixel values within a matrix where the amount of averaging or blurring is defined by the coefficient applied to the reference pixel. With reference to Table 1, the absolute value of the summed differences is compared to a threshold range to determine a blur level to be applied to the data. As mentioned above, the threshold range corresponds to a coefficient to be applied to the reference pixel during an averaging calculation applied to the matrix that applies the blur effect. It should be appreciated that while de-noise unit 112 is illustrated as a separate unit from camera 114 and device 102, this is not meant to be limiting. That is de-noise unit 112 may be incorporated into either image capture device 114 or computing unit 102. With reference to FIG. 1, each of the above mentioned function blocks may be integrated into computing unit 102, e.g., a cell phone.

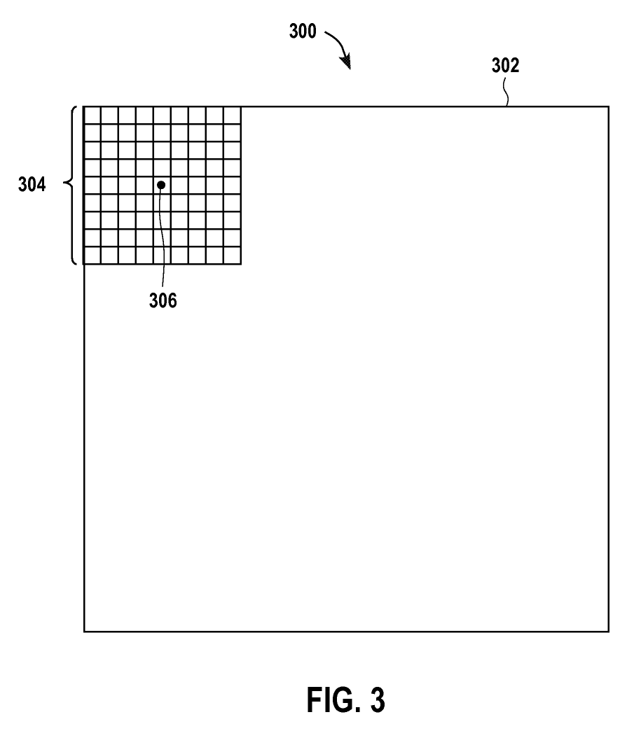

FIG. 3 is a simplified schematic diagram of view 300 of a captured image 302 with a corresponding pixel matrix 304, in accordance with one embodiment of the invention. In one embodiment, matrix 304 is a 9×9 matrix, i.e., the matrix is composed of 9 pixels across (a row of pixels) and 9 pixels down (a column of pixels). In this embodiment, the center pixel 308 is the actual center of the 9×9 matrix, i.e., the center is 5 pows across and 5 pows down from a top left hand corner of the matrix. Although the reference pixel is the actual center pixel of the 9×9 pixel matrix, this is not meant to be limiting. If there are an even number of rows and columns which form the pixel matrix there will not be an actual geometric center. In that case, when the matrix is made up of an even number of pixels (or even if there are an odd number of pixels as in the 9×9 example), any pixel in the matrix may be chosen as the reference pixel 306, as long as this pixel location is chosen consistently for each successive matrix for the blur calculation. Once center pixel 306 is identified, the absolute value of the difference between the value of center pixel 306 and all the remaining pixel values in the 9×9 matrix 304 are added together which results in a sum of the differences. A blurring level is selected through the value of the sum of differences as mentioned above with reference to Table 1. If based on that comparison a determination is made that some level of blurring needs to be applied, then the blurring will be applied to blur center pixel 306. As discussed above, the blurring level is calculated by averaging the values in subset matrix 308 in one embodiment. Thus, where the matrix is a 3×3 matrix and where the coefficient determined from the sum of the differences is 4, then the values of the pixel values in the 3×3 matrix are added together, with the center or reference pixel value being added 4 times. Thus, the sum of the 3×3 matrix values, with the center value considered four times, is divided by 12 to arrive at the average value. This average value replaces the previous value for the reference pixel through selection of the filtered pixel value by the multiplexer of FIG. 2.

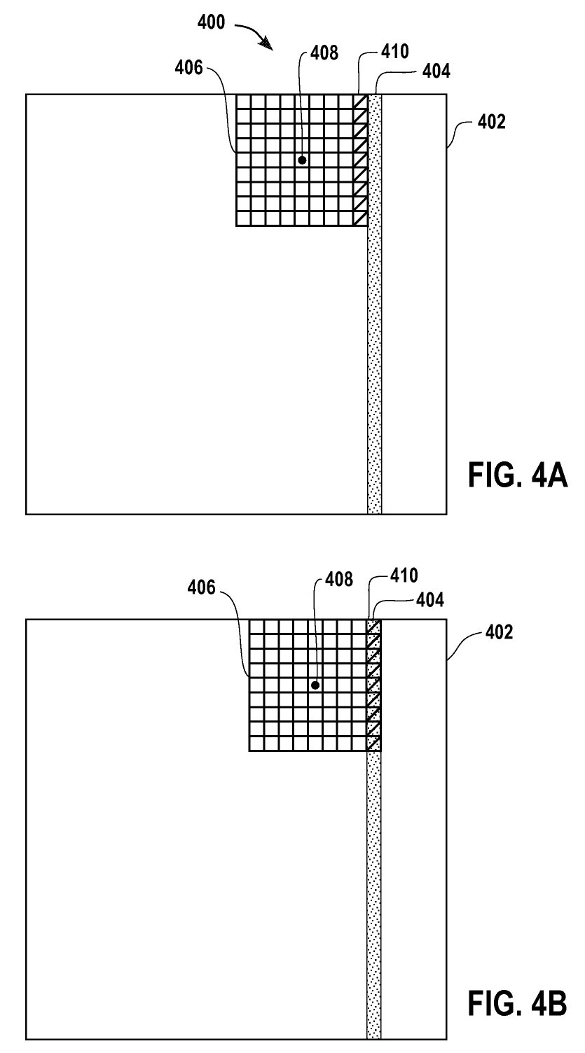

FIG. 4A is a simplified schematic diagram illustrating view 400 of a pixel matrix 406 which has not yet entered an edge area, or transition area 404, in accordance with one embodiment of the present invention. FIG. 4A has a 9×9 pixel matrix 406 with a pixel center 408. In this embodiment the far right column of 9 pixels 410, as well as the remaining pixels within the 9×9 pixel matrix, is completely composed of an area that lacks detail or transitions, such as a background area of the image 402. The 9×9 matrix has not yet entered a transition area 404 of image 402. That is, the pixel values are similar in value for each of the pixels within matrix 406. In this embodiment, a comparison between the center pixel 408 and all the remaining pixels in the 9×9 pixel matrix 406 would result in a sum of differences equaling zero or a relatively low value. Therefore, a relatively large amount of blurring could be applied to center pixel 408 without any significant loss of detail when displaying the resulting blurred image. It should be appreciated that a transition area is any area where the image has an edge or some detail. One skilled in the art will appreciate that this technique works for both black and white images, as well as for colored images because the technique relies on a comparison of pixel values. Pixels representing black, white, or different colored pixels all have different pixel values, and the technique described in the various embodiments herein is applicable to different color formats.

FIG. 4B is a 9×9 pixel matrix 406 with a pixel center 408. The far right column of 9 pixels 410 has entered a transition area 404 of image 402. A comparison between the center pixel 408 and all the remaining pixels in the 9×9 pixel matrix 406 would result in a sum of differences equaling a value greater than the value from FIG. 4A. In this embodiment, therefore, any amount of blurring would be applied to the center pixel based on a comparison to a threshold level. The threshold level would allow graduated or variable levels of blurring to be applied to the image depending on how much detail, i.e., differences in pixel values there was in the matrix area of the image. For example, the more detail in the matrix area of the image, the less blurring would be applied, and at some point, a certain amount of transitions and edges in the matrix area results in no blurring applied to the image 402. It should be noted that the higher the coefficient used for the reference or the center pixel in the averaging calculation, the less blur is applied to the pixel. It should be appreciated that the process described above proceeds across the rows of the image advancing one column at a time from left to right and then returning to the left hand side and moving down one row, and so on, in a rasterization pattern. In addition, in one embodiment, in order to account for the corner pixels for filtering when the pixel matrix is a 9×9 and the reference pixel is the center pixel, the four rows under the center pixel can be translated to correspond to the rows above the first row. That is, the bottom four rows can be given row numbers −1 through −4, and the same can be done with the last four columns to essentially translate the 9×9 matrix so that the center is the first pixel in the top left hand corner. Alternatively, a border may be applied to around the image data.

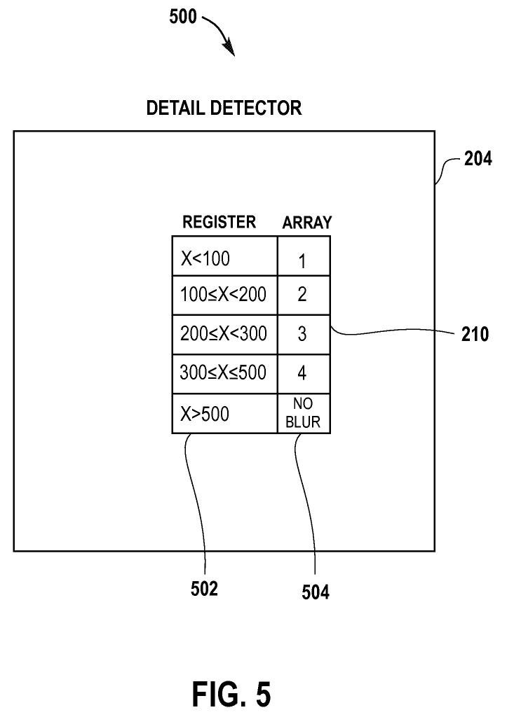

FIG. 5 shows a representation 500 of the detail detector 204 and possible values stored in a register array 210, in accordance with one embodiment of the present invention. In one embodiment, column 502 of register array 210 represents threshold range values stored in the registers, and column 504 represents filter coefficients. The variable x represents a sum of differences between a center pixel value, or a reference pixel value, and the remaining pixel values in a pixel matrix. For example, if a comparison of the center pixel value to the remaining pixel values in a pixel matrix results in a sum of differences of 350, then as shown in register array 210, a corresponding filter coefficient of 4 is selected. That is, a value of 4 is applied as a filter coefficient because a sum of differences of 350 corresponds to a threshold range of 300≦x≦500, as shown in column 502 of register array 210. Thus, the center pixel would be considered 4 times to calculate an average of a subset of the pixel matrix that was used to determine the sum of the differences. As mentioned above, register array 210 is an exemplary array and the exemplary arranges and coefficient values are not meant to be limiting in either the size of the ranges or the number of ranges.

FIG. 6 is a flow chart 600 illustrating method operations for providing a variable blur, in accordance with one embodiment of the present invention. The method initiates with operation 602 where images are captured through an image capture device, e.g. a digital camera or other electronic image capturing device. It should be understood by those skilled in the art that the methods described herein may be extended to any image data represented in electronic form. For example, a non-electronic image such as a photograph may be converted into electronic form through a scanner, and the embodiments described herein may be applied to the electronic representation.

The method then advances to operation 604 where a value representing a center pixel or reference pixel is compared to every other value in the pixel matrix. In one embodiment a pixel matrix size is selected in operation 604 and the pixel values of the matrix are stored. A line buffer or other storage element may be used for this purpose. A pixel matrix is a subset of the image data and consists of a selected number of rows and columns of pixels of the image data. Also in operation 604, a reference pixel is chosen, and in one embodiment the reference pixel may be a center pixel. Even if there is an actual center in the matrix, as previously explained above in the description of FIG. 3, any pixel in the matrix may be designated as the reference pixel. In one embodiment, a 9×9 matrix may be chosen. A 9×9 matrix consists of 9 pixels across the image (a row of pixels) and 9 pixels down the image (a column of pixels). Typically the pixel matrix is initial placed in an upper left corner of the image data and proceeds to scan the data in a rasterization pattern, however, any pixel area that accommodates the 9×9 matrix may be selected as a starting point for the matrix. It should be noted that the number of rows chosen does not have to be the same as the number of columns chosen, i.e. the matrix does not have to be square. In operation 604 the absolute value of the difference between the center pixel value and each other pixel value within the matrix is captured. The comparing is done sequentially in one embodiment. That is, the center pixel value is compared to one other pixel value in the pixel matrix, then the center pixel value is compared to another pixel value in the pixel matrix, and so on until the center pixel value has been compared to every pixel value within the matrix. However, it should be appreciated that the individual comparisons may alternatively be accomplished as parallel operations.

From operation 604, the method proceeds to operation 606, where the differences between the value of the center pixel and every other pixel calculated in operation 604 are summed. It should be appreciated that operations 604 and 606 may be executed through hardware. That is, logic gates, e.g., adders, subtractors, comparators, and other known logic gates may be used to execute the operations described herein. Of course, the embodiments described herein may be executed through computer code stored within a memory also. From operation 606, the method proceeds to operation 608, where a blur level is selected to filter a subset of the pixel matrix based on the summed differences from operation 606. Here, the summed difference is evaluated to select a threshold value as discussed above with regard to Table 1. For example, the summed difference may be compared to determine the appropriate range, which in turn corresponds to a coefficient value. It should be appreciated that the blurring technique removes some of the noise associated with electronic images to smooth out portions of the image.

Blurring is accomplished by averaging the pixel values within a selected pixel matrix to remove the noise associated with digital images and especially the images captured through cell phones with or without flash capability. In one embodiment, blurring is accomplished by averaging pixel values within the pixel matrix. The average value is then substituted for the reference pixel. Achieving different blur levels is accomplished by determining an amount of repetition for the reference pixel value in the filter, i.e., how many times to use the center pixel value when calculating the average. This blurring coefficient determines the blur level applied to the reference pixel and this coefficient corresponds to a threshold value range which is related to the sum of the differences computed in operation 606. In one embodiment, a table of ranges may be stored and accessed or looked up for determination of the coefficient through comparison operations in operation 608. For example, referring to Table 1, if the sum of differences is found to be between 100 and 200, a coefficient of 2 is chosen in operation 608. For a 9×9 matrix, the average would be calculated as follows: [(value of center pixel+value of center pixel)+(sum of all other 80 pixel values in the matrix)]/82. This result would represent the average of the 9×9 matrix chosen with a coefficient of 2 applied, i.e, the center pixel value is considered twice in the average. This averaging removes the noise associated with the image by reducing the pixel values, where the reference pixel value includes noise, within the pixel matrix.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

What is claimed is:

1. A method for providing a variable blur to improve picture quality, comprising method operations of:
receiving captured image data;
comparing a value representing a center pixel of a pixel matrix to each pixel value within the pixel matrix;
summing differences between the center pixel value and each pixel value; and
selecting a blur level to filter the center pixel of the pixel matrix based on the summed differences.

2. The method of claim 1, wherein the method operation of selecting the blur level to filter the center pixel of the pixel matrix based on the summed differences further comprises,
comparing the summed differences to a range of threshold values; and
blurring the subset of the pixel matrix according to the comparing.

3. The method of claim 2, wherein the method operation of blurring the center pixel of the pixel matrix according to the comparing includes,
averaging pixel values within the subset of the pixel matrix.

4. The method of claim 1, wherein the method operation of selecting the blur level to filter the center pixel of the pixel matrix based on the summed differences includes, determining an amount of repetition for the center pixel value in the filter.

5. The method of claim 2, wherein the method operation of comparing the summed differences to a range of threshold values includes,
selecting a coefficient to be applied to the center pixel of the pixel matrix.

6. The method of claim 1, further comprising:
identifying an edge region within the pixel matrix; and
selecting unfiltered data to avoid losing sharpness of the edge region.

7. A de-noising circuit for filtering image data, comprising:
a buffer for storing a portion of the image data;
detail detection circuitry configured to determine a filter coefficient to be applied to a reference pixel value within the portion of the image data;
a blur filter configured to average the reference pixel, the blur filter repeating the reference pixel value for averaging as specified by the filter coefficient to generate blurred image data; and
selection circuitry configured to select between the blurred image data and data from the buffer based on a selection signal from the detail detection circuitry.

8. The de-noising circuit of claim 7, wherein the selection circuitry is a multiplexer receiving input from the buffer, the detail detection circuitry, and the blur filter.

9. The de-noising circuit of claim 7, wherein the detail detection circuitry includes a register array having a plurality of filter coefficients stored therein, the register array further includes data representing a threshold range associated with each of the plurality of filter coefficients.

10. The de-noising circuit of claim 7, wherein a depth of the line buffer equals one of a number of rows or a number of columns of the portion of the image data.

11. The de-noising circuit of claim 7, wherein the denoising circuit is integrated onto a graphics controller.

12. A portable device, comprising:
image capture circuitry;
a graphics processor; and
de-noising circuitry in communication with the image capture circuitry and the graphics processor, the de-noising circuitry includes,
a line buffer configured to receive a portion of captured image data from the image capture circuitry;
detail detection circuitry configured to calculate a difference between a center pixel value of the portion of captured image data and a remainder of pixel values within the portion of captured image data; and
a blur filter configured to apply a blur level to the center pixel value.

13. The portable device of claim 12, wherein the detail detection circuitry includes a register array containing a set of threshold values.

14. The portable device of claim 13, wherein the register array includes coefficients corresponding to each of the set of threshold values.

15. The portable device of claim 12, wherein the blur filter is configured to apply the blur level according to an output of the detail detection circuitry.

16. The portable device of claim 15, wherein the output of the detail detection circuitry is a selection signal selecting between unfiltered data and averaged data.

17. The portable device of claim 15, wherein the output identifies a respective coefficient to be applied for calculation of the blur level.

18. The portable device of claim 12, wherein the line buffer is a minimum of 9 lines deep.

19. The portable device of claim 12, wherein the detail detection circuitry is configured to communicate with the blur filter and a multiplexer, the multiplexer configured to select between output of the line buffer and the blur filter based on output from the detail detection circuitry.

20. The portable device of claim 12, wherein the portable device is a cell phone.
